(19) United States
(12) Patent Application Publication
(10) Pub. No.: US 2017/0312893 A1
(43) Pub. Date: Nov. 2, 2017

(54) Wrench

(71) Applicants: Hangzhou Great Star Industrial Co., Ltd., Hangzhou City (CN); Hangzhou Great Star Tools Co., Ltd., Hangzhou City (CN)

(72) Inventor: Min Wang, Hangzhou City (CN)

(21) Appl. No.: 15/524,343

(22) PCT Filed: Nov. 4, 2014
(86) PCT No.: PCT/CN2014/090227

§ 371 Date: May 4, 2017

(51) Int. Cl. B25B 13/26; B25B 13/14

(52) U.S. Cl. CPC B25B 13/26; B25B 13/14

(57) ABSTRACT

Disclosed is a wrench, comprising a jaw locking mechanism (10) in the form of an ejector pin, being used to limit a sliding connection component (23, 241, 242) to move relative to a body (2) in a direction toward or away from a fixed jaw (4), and further comprising a handle locking mechanism which is used to limit or allow the rotation of a handle (3) relative to the body (2). By means of the wrench, continuous and multiple rotation of a workpiece is achieved.

### FIELD OF THE INVENTION

The present invention relates to a wrench, pertaining to the field of hand tools.

### DESCRIPTION OF THE PRIOR ART

An adjustable wrench usually comprises a fixed jaw and a movable jaw for clamping a workpiece, where the movable jaw can move toward or away from the fixed jaw. By adjusting the distance between the fixed jaw and the movable jaw, the wrench can tightly clamp a series of workpieces of various sizes, and the workpieces can be screwed or unscrewed by rotating a handle.

When an ordinary adjustable wrench is used, a user adjusts the distance between the fixed jaw and the movable jaw, and places the wrench on the workpiece. In most service environments, the handle of the wrench can only rotate by a relatively small angle, thus the workpiece can be screwed or unscrewed only by continuous and multiple rotations. Between two rotations, pauses are required for temporary removals of the wrench from the workpiece, and place it on the workpiece again so as to resume the operation. Sometimes, another hand is needed to help. Therefore, this operation is very inconvenient.

A ratchet wrench can simplify such operations. Among multiple rotations, it is unnecessary to remove the ratchet wrench from the workpiece and place it on the workpiece again.

However, it is not easy to incorporate a ratchet and an adjustable function into a wrench, which leads to a relatively complex structure, difficult tool fabrication and relatively high costs. Additionally, when a torque is relatively large, the wrench could be damaged.

Therefore, those skilled in the art endeavors to produce a ratchet wrench with a simple structure, so as to quickly rotate the workpiece and improve the work efficiency of the wrench.

### SUMMARY OF THE INVENTION

In view of the above defects of the prior art, the technical problem to be solved by the present invention is to provide a wrench with a simple structure, which can achieve continuous and multiple rotation of the workpiece without removing the wrench from the workpiece and placing it on the workpiece again, thereby improving the work efficiency of the wrench; meanwhile, due to the simple structure, the wrench can be firm in fabrication. The wrench is not prone to be damaged when the torque is relatively large. In addition, the simple structure simplifies the fabrication process of the wrench and reduces the fabrication cost.

The present invention provides a wrench, comprising a body, a fixed jaw fixedly connected to the body, a movable jaw, a sliding connection component and a handle rotationally connected to the body, wherein the movable jaw forms a sliding connection with the body via the sliding connection component, wherein the wrench further comprises a jaw locking mechanism rotationally connected to a handle, which is used to limit the movement of the sliding connection component relative to the body in a direction toward or away from the fixed jaw, the wrench further comprising a handle locking mechanism.

When the handle is rotated relative to the body in a counter-clockwise direction, the handle drives the jaw locking mechanism to change to an unlocking state from a locking state. Under an external force, the movable jaw can move in a direction away from the fixed jaw.

The wrench provided by the present invention is used for a standard right-hand thread workpiece.

When the handle is rotated relative to the body in a counter-clockwise direction, the handle drives the jaw locking mechanism to change to the unlocking state from the locking state through the rotational connection with the body, such that the sliding connection component can move relative to the body in a direction toward or away from the fixed jaw, thus the movable jaw can move in a direction toward or away from the fixed jaw under an external force.

At this point, the handle is continuously rotated in a counter-clockwise direction, and there is no relative rotation between the handle and the body, but the jaws are rotated relative to the workpiece. Usually, the workpiece is a hexagon nut. The jaws turn to a position of clamping opposite vertexes of the hexagon nut from a position of clamping opposite surfaces of the hexagon nut. In this process, with the increased dimension of the hexagon nut clamped between the jaws, the hexagon nut applies an action force to the movable jaw and the fixed jaw. Under the action force, the movable jaw moves in a direction away from the fixed jaw, thereby increasing the distance between the movable jaw and the fixed jaw, so as to make the jaws to slide over the vertexes of the workpiece and reach a next position of clamping the opposite surfaces of the hexagon nut. At this position, the handle is rotated relative to the body in a direction of screwing the workpiece, that is, to rotate the handle in a clockwise direction. With the rotation of the handle, the workpiece is screwed.

If the workpiece is continued to be screwed, then the handle is rotated again in a counter-clockwise direction, which increases the distance between the fixed jaw and the movable jaw, and makes the fixed jaw and the movable jaw to slide over the vertexes of the workpiece. The handle is rotated again in a clockwise direction to screw the workpiece, thereby achieving the continuous and multiple rotation of the workpiece, without the need to remove the wrench from the workpiece or place it on the workpiece again, thereby improving the work efficiency of the wrench.

The wrench provided by the present invention further comprises a handle locking mechanism. As with the ordinary wrench, if the handle locking mechanism is located at a locking position, then the handle cannot rotate relative to the body.

It can be understood that the wrench provided by the present invention can be used for screwing a left-hand thread workpiece or unscrewing the right-hand thread workpiece when simply used in an inverted manner.

The following description is for the right-hand thread workpiece.

Further, the body is integrally formed with the fixed jaw.

Further, the jaw locking mechanism is an ejector pin.

The adoption of the ejector pin as the jaw locking mechanism allows the wrench to be fabricated to be stronger. The wrench is not prone to be damaged when the torque is relatively large. Meanwhile, due to the simple structure, the fabrication process of the wrench is simplified and the fabrication costs are lowered.

Further, the sliding connection component comprises an axis pin and a worm gear provided around the axis pin, wherein the axis pin is provided in a through-hole of the body, a first end of the ejector pin extends into the through-hole to prevent the axis pin from sliding, the jaw locking mechanism is in a locked state, the first end of the ejector pin retreats from the through-hole, the axis pin is slidable and the jaw locking mechanism is in an unlocked state.

With the wrench provided by the present invention, the axis pin is provided in the through-hole of the body, the first end of the ejector pin extends into the through-hole to prevent the axis pin from sliding, and the jaw locking mechanism is in a locked state. At this point, the jaws are turned to a position of clamping opposite vertexes of the hexagon nut from a position of clamping opposite surfaces of the hexagon nut. In this process, with the increased dimension of the hexagon nut clamped between the jaws, the hexagon nut applies an action force to the movable jaw and the fixed jaw. The first end of the ejector pin extends into the through-hole to limit the movement of the axis pin, thereby limiting the movement of the movable jaw in a direction away from the fixed jaw. The distance between the movable jaw and the fixed jaw cannot be increased; therefore the jaw cannot slide over the vertexes of the workpiece or reach the next position of clamping the opposite surfaces of the hexagon nut.

The first end of the ejector pin retreats from the through-hole, and the axis pin is slidable. When the jaw locking mechanism is in the unlocked state, the hexagon nut exerts the external force to the movable jaw and the fixed jaw, such that the movable jaw moves in a direction away from the fixed jaw, which increases the distance between the movable jaw and the fixed jaw, thereby sliding over the vertexes of the workpiece and reaching the next position of clamping the opposite surfaces of the hexagon nut.

Further, the first end of the ejector pin is a column body which is partly cut out by a plane; the plane does not pass through an axis of the ejector pin and is parallel with the axis of the ejector pin, such that a contact surface between the ejector pin and the axis pin is a flat plane.

By means of such a structure, the contact surface between the ejector pin and the axis pin is a flat plane, and the first end of the ejector pin can reliably prevent the axis pin from sliding. Even if the torque is relatively large, the wrench is not prone to jamming or malfunctions, and a contact area between the axis pin 6 and the ejector pin 10 is increased as much as possible.

Further, the worm gear is provided in a hollow cavity of the body, and a length of the worm gear in an axial direction of the axis pin is less than that of the hollow cavity, such that the movable jaw can move in a direction away from the fixed jaw when acted upon by an external force.

Further, a first end of the axis pin is provided with a first elastic part therearound, such that the jaw automatically restores without an external force.

Further, the first elastic part is provided inside a hole of the body, which prevents the first elastic part from contacting greasy dirt in use, while making the wrench provided by the present invention more aesthetically pleasing.

Further, a second end of the ejector pin forms a rotational connection with a first recess of the handle. When rotating relative to the body in a counter-clockwise direction, the handle drives the ejector pin to move via the rotational connection formed by the second end of the ejector pin and the first recess of the handle, such that the first end of the ejector pin drops out from an annular groove of the axis pin, and the jaw locking mechanism is changed to the unlocked state from the locked state.

Further, the second end of the ejector pin is a cylindrical structure. An axis of the cylinder is perpendicular to that of the ejector pin and is parallel with the contact surface between the ejector pin and the axis pin. The adoption of the cylindrical structure ensures the firm and reliable rotational connection between the ejector pin and the handle, such that the wrench is not prone to be damaged when the torque is relatively large; the axis of the cylinder being parallel with the contact surface between the ejector pin and the axis pin ensures that the first end of the ejector pin is always contacting the axis pin in a flat plane.

Further, the first recess of the handle has an arc profile, such that the rotational connection between the ejector pin and the handle can rotate flexibly.

Further, a central angle corresponding to the arc profile is greater than 180 degrees, such that the second end of the ejector pin is not easily dropped out from the first recess of the handle, which further ensures the firm and reliable rotational connection between the ejector pin and the handle, such that the wrench is not prone to be damaged when the torque is relatively large.

Further, a side face of the handle relative to a first side face of the body comprises a first side face that is parallel with the first side face of the body, and a second side face forming an included angle of less than 5 degrees with the first side face of the body.

The first side face of the handle is parallel with that of the body, such that the handle cannot rotate relative to the body in a clockwise direction, which is to say that when the handle is rotated in a clockwise direction, the jaw locking mechanism does not change to the unlocked state from the locked state, but just to screw the workpiece.

The second side face of the handle forms an included angle of less than 5 degrees with the first side face of the body, such that the handle can rotate relative to the body in a counter-clockwise direction, so the jaw locking mechanism is changed to the unlocked state from the locked state, and the movable jaw can move in a direction away from the fixed jaw, thereby increasing the distance between the fixed jaw and the movable jaw, and making the fixed jaw and the movable jaw to pass over the vertexes of the workpiece.

Further, the second side face of the handle is provided with a blind hole, and a second elastic part is arranged in the blind hole. An elastic force provided by the second elastic part keeps the jaw locking mechanism in the locked state, which avoids the occurrence of unreliable locking in use.

Further, the worm gear has a double thread structure, which shortens the time required to adjust the distance between the jaws while increasing the torque bearable by the worm gear.

Further, the handle locking mechanism is at the locking position, and the handle cannot rotate relative to the body; the handle locking mechanism is at the unlocking position, and the handle can rotate relative to the body.

The wrench provided by the present invention further comprises a handle locking mechanism. The handle locking mechanism is at the locking position, and the handle cannot rotate relative to the body. As the ordinary wrench, when the handle is rotated in a clockwise direction, the workpiece is screwed; when the handle is rotated in a counter-clockwise direction, the workpiece is unscrewed. The handle locking mechanism is at the unlocking position, and the handle can rotate relative to the body. When the handle is rotated in a clockwise direction, the workpiece is screwed; when the handle is rotated in a counter-clockwise direction, the jaw locking mechanism is changed to the unlocked state from the locked state, such that the movable jaw can move in a direction away from the fixed jaw, thereby increasing the distance between the fixed jaw and the movable jaw, and making the fixed jaw and the movable jaw to pass over the vertex of the workpiece.

Further, the handle locking mechanism comprises a button and a stop block, wherein the button is used to move the handle locking mechanism between the locking position and the unlocking position, and the stop block is used to limit the rotation of the handle relative to the body.

Further, the stop block matches with the second recess of the handle to limit the handle to rotate relative to the body.

Further, a cross-section of the stop block is a right trapezoid.

Further, the profile of the cross-section of the second recess is rectangular, and matches with a rectangular part of the right trapezoid of the stop block.

Compared to the prior art, the wrench provided by the present invention has the following advantageous effects.

(1) When the handle rotates relative to the body in a counter-clockwise direction, the jaw locking mechanism is changed to the unlocked state from the locked state, and the distance between the fixed jaw and the movable jaw is increased under the external force, thereby making the fixed jaw and the movable jaw to pass over the vertexes of the workpiece, which achieves the continuous and multiple rotation of the workpiece, without the need to remove the wrench from the workpiece or place it on the workpiece again, thereby improving the work efficiency of the wrench.

(2) The wrench is simple in structure, can bear a relatively large torque, simplifies the fabrication process and lowers the fabrication cost.

(3) The first elastic part is provided internally, which prevents the first elastic part from contacting greasy dirt in use while making the wrench more aesthetically pleasing.

(4) The worm gear has a double thread structure, which not only shortens the time required to adjust the distance between the jaws but also increases the torque bearable by the worm gear.

The conception, specific structures and technical effects of the present invention will be further illustrated below in conjunction with the accompanying drawings, in order to fully understand the objects, features and effects of the present invention.

### BRIEF DESCRIPTION OF THE DRAWINGS

FIG. 1 is a front view of the wrench according to one embodiment of the present invention;

FIG. 2 is a section view of the body of the wrench shown in FIG. 1;

FIG. 3 is a partial section view of the jaw locking mechanism of the wrench shown in FIG. 1 in a locked state;

FIG. 4 is a structural schematic diagram of the movable jaw of the wrench shown in FIG. 1;

FIG. 5 is a connection relation schematic diagram of the jaw locking mechanism of the wrench shown in FIG. 1;

FIG. 6 is a partial section view of the jaw locking mechanism of the wrench shown in FIG. 1 in an unlocked state;

FIG. 7 is a perspective view of the ejector pin of the jaw locking mechanism of the wrench shown in FIG. 1;

FIG. 8 is a partial section view of the handle locking mechanism of the wrench shown in FIG. 1 in a locked state;

FIG. 9 is a partial section view of the handle locking mechanism of the wrench shown in FIG. 1 in an unlocked state; and

FIG. 10 is a partial section view of the handle locking mechanism of the wrench shown in FIG. 1 in a locked state.

### DETAILED DESCRIPTION OF THE PREFERRED EMBODIMENTS

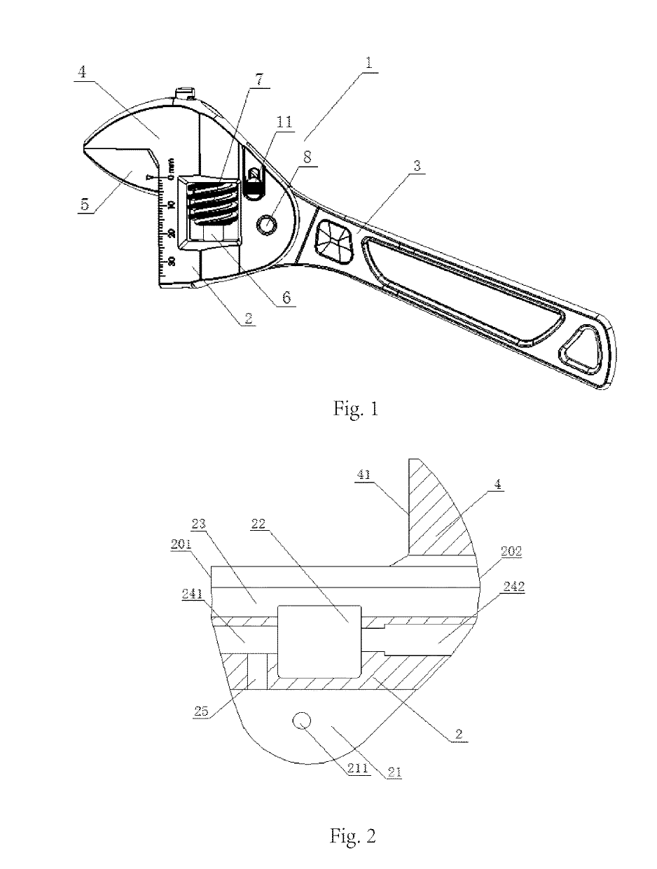

As shown in FIG. 1, the wrench 1 according to one embodiment of the present invention includes a body 2, a handle 3, a fixed jaw 4, a movable jaw 5 and an ejector pin 10.

The size of the handle 3 is designed to be suitable for holding by a user, and the handle 3 may include an injection sleeve to improve the grip comfort.

The fixed jaw 4 is fixedly connected to the body 2, or can be integrally formed with the body 2. In the present embodiment, the fixed jaw 4 is integrally formed with the body 2.

The body 2, the fixed jaw 4 and the movable jaw 5 may be made of cast steel or other high-strength materials.

As shown in FIG. 2, the fixed jaw includes a jaw surface 41 which contacts the workpiece when the wrench is operated. Here, the workpiece may include any apparatus, part or fastener clamped by the wrench 1. The typical workpiece is a torqued fastener, such as a screw, a hexagon nut, a pip fitting or the like.

The body 2 includes an approximately rectangular hollow cavity 22.

The body 2 further includes an elongate track 23 which extends from one side face 201 of the body 2 toward the body 2 to below the fixed jaw 4. In the present embodiment, the track 23 extends to another side face 202 of the body 2. In this way, two ends of the track 23 have openings. The track 23 is provided with an opening along an upper edge, i.e. the edge in a direction toward the fixed jaw 4, so as to house the movable jaw 5. The track 23 is provided such that the movable jaw 5 moves toward and away from the fixed jaw 4 in a direction perpendicular to the jaw surface 41 of the fixed jaw 4, and the track 23 is communicated with the hollow cavity 22.

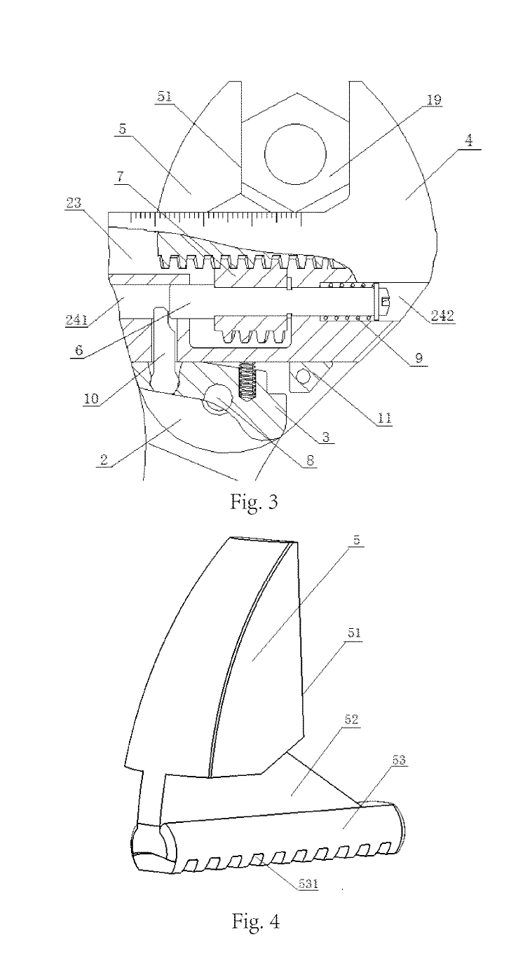

As shown in FIG. 3, the movable jaw 5 is mounted onto the body 2 and forms a sliding connection with the body 2. The movable jaw 5 includes a jaw surface 51 facing the jaw surface 41 of the fixed jaw 4, which contacts the workpiece when the wrench is operated. Here, the workpiece is a hexagon nut 19 which is clamped between the jaw surface 51 and the jaw surface 41.

As shown in FIG. 4, the movable jaw 5 also includes a neck portion 52 and a flange 53, where the flange 53 is slidable in the track 23. With the movable jaw 5 being provided with the neck portion 52, the track 23 also has a similar cross-section with a slightly large size, such that the movable jaw 5 does not disengage from the opening at the upper edge of the track 23 when the movable jaw 5 reciprocates toward or away from the fixed jaw 4.

A toothed structure of the flange 53 forms a rack 531 which extends toward the hollow cavity 22 from the track 23.

One or two ends of the track 23 may be provided with a stop block to prevent the movable jaw 5 from sliding out of the track 23.

As shown in FIG. 3, the worm gear 7 is arranged in the hollow cavity 22 and is provided around the axis pin 6.

One end of the axis pin 6 is arranged in a through-hole 241 from the side face 201 of the body 2 to the hollow cavity 22, and the other end of the axis pin 6 is arranged in a through-hole 242 from the hollow cavity 22 to the side face 202 of the body 2.

The rack 531 of the flange 53 of the movable jaw 5 mates with the worm gear 7. In this way, the rotation of the worm gear 7 switches the movement of the movable jaw 5 toward or away from the fixed jaw 4.

Along an axial direction of the axis pin 6, the length of the worm gear 7 is less than that of the hollow cavity 22. When an external force is exerted to the jaw surface 51 of the movable jaw 5, the movable jaw 5 drives the worm gear 7 and the axis pin 6 via the rack 531 to move in a direction away from the fixed jaw 4, and the distance between the jaw surface 51 of the movable jaw 5 and the jaw surface 41 of the fixed jaw 4 can be increased.

One end of the axis pin 6 arranged in the through-hole 242 is provided with a first elastic part which is provided therearound. In the present embodiment, the first elastic part is a spring 9. The through-hole 242 includes two segments of through-hole of different diameters, with a smaller diameter of the through-hole adjacent to the hollow cavity 22 and a larger diameter of the through-hole away from the hollow cavity 22, to house the axis pin 6 around which the first elastic part is provided.

The spring 9 is used for automatic restoration of the axis pin 6 when without any external force, thereby driving the movable jaw 5 to restore.

The spring 9 is arranged inside the through-hole 242 of the body 2, which prevents the spring 9 from contacting greasy dirt in use, and meanwhile make the wrench provided herein more aesthetically pleasing.

The axis pin 6 is arranged in the through-hole 241.

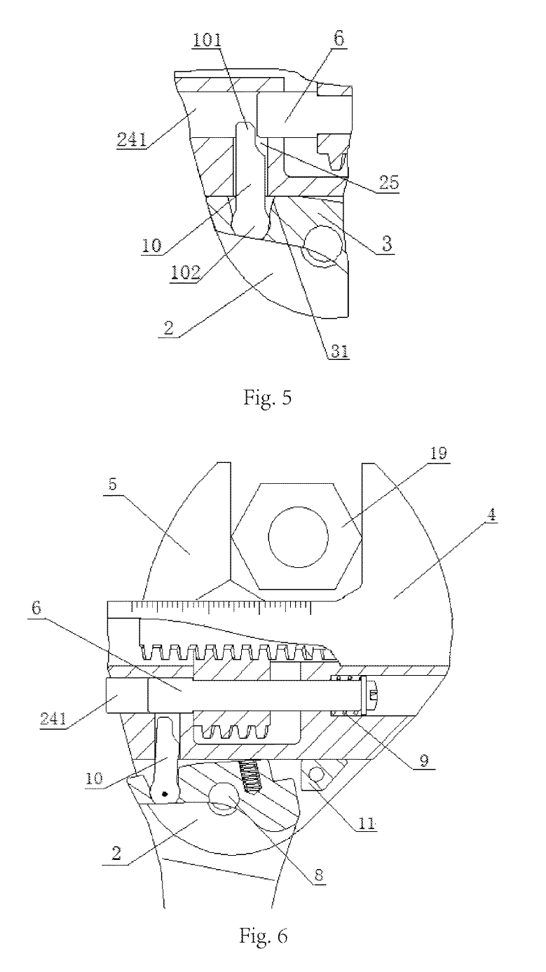

As shown in FIG. 5, a second end 102 of the ejector pin 10 is arranged in a first recess 31 of the handle 3. The ejector pin 10 is rotatable relative to the handle 3. The ejector pin 10 passes through the through-hole 25 of the body 2. The first end 101 of the ejector pin 10 extends into the through-hole 241 to prevent the axis pin 6 from sliding, and the jaw locking mechanism is in the locked state. The first end 101 of the ejector pin 10 retreats from the through-hole 241, the axis pin 6 is slidable, and the jaw locking mechanism is in the unlocked state.

When the handle 3 is rotated relative to the body 2 in a counter-clockwise direction, the ejector pin 10 is driven to move via the rotational connection formed by the second end 102 of the ejector pin 10 and the recess 31 of the handle 3, such that the first end 101 of the ejector pin retreats from the through-hole 241, the axis pin 6 is slidable, and the jaw locking mechanism is changed to the unlocked state from the locked state.

The wrench in the present embodiment is used for the standard right-hand thread fastener, and the workpiece is a hexagon nut 19.

As shown in FIG. 3, the moveable jaw 5 and the fixed jaw 4 clamp the hexagon nut 19 at positions of the opposite faces thereof. The handle 3 drives the ejector pin 10 via the rotational connection between it and the body 2 upon counter-clockwise rotation of the handle 3 relative to the body 2, to change the jaw locking mechanism to the unlocked state from the locked state.

At this point, the handle 3 is continued to be rotated in a counter-clockwise direction, and there is no more relative rotation between the handle and the body, but the jaws are caused to rotate relative to the hexagon nut 19, turning to a position of clamping opposite vertexes of the hexagon nut 19 from a position of clamping opposite surfaces of the hexagon nut 19. As shown in FIG. 6, in this process, with the increased dimension of the hexagon nut 19 that is clamped between the jaws, the hexagon nut 19 applies an action force to the movable jaw 5 and the fixed jaw 4. Under this action force, the movable jaw 5 can move in a direction away from the fixed jaw 4, thereby increasing the distance between the movable jaw and the fixed jaw, so as to make the jaws to slide over the vertexes of the hexagon nut 19 and reach a next position of clamping the opposite surfaces of the hexagon nut 19. At this position, the handle 3 is rotated relative to the body 2 in a screw in direction of the workpiece, that is, to rotate the handle in a clockwise direction. With the rotation of the handle 2, the hexagon nut 19 is screwed in.

If the hexagon nut 19 is needed to be further screwed in, then the handle 3 is rotated again in a counter-clockwise direction, which increases the distance between the fixed jaw 4 and the movable jaw 5, and makes the fixed jaw 4 and the movable jaw 5 to slide over the vertexes of the hexagon nut 19. The handle 3 is rotated again in a clockwise direction to screw the hexagon nut 19, thereby achieving the continuous and multiple rotation of the hexagon nut 19, without the need to remove the wrench from the hexagon nut 19 or place it on the hexagon nut 19 again, thereby improving the work efficiency of the wrench.

It can be understood that the wrench provided by the present invention can be used for screwing a left-hand thread workpiece or unscrewing the right-hand thread workpiece when simply used in an inverted manner.

As shown in FIG. 7, the first end 101 of the ejector pin is a column body that is partly cut out by a plane 1011, plane 1011 does not pass over the axis of the ejector pin 10 and is parallel with the axis of the ejector pin 10, such that a contact surface between the ejector pin 10 and the axis pin 6 is a flat plane.

By means of such a structure, the contact surface between the ejector pin 10 and the axis pin 6 is a flat plane, the first end 101 of the ejector pin 10 can reliably prevent the axis pin 6 from sliding, the wrench is not prone to jamming or malfunction even if the torque is relatively large, and a contact area between the axis pin 6 and the ejector pin 10 is increased as much as possible.

The second end 102 of the ejector pin 10 is a cylindrical structure. An axis of the cylinder is perpendicular to that of the ejector pin 10, and is parallel with the contact surface between the ejector pin 10 and the axis pin 6, which ensures that the first end 101 of the ejector pin 10 is always contacting the axis pin 6 in a flat plane. The adoption of the cylindrical structure ensures the firm and reliable rotational connection between the ejector pin and the handle, such that the wrench is not prone to be damaged when the torque is relatively large.

The first recess 31 of the handle 3 has an arc profile, such that the rotational connection between the ejector pin 10 and the handle 3 can rotate flexibly.

A central angle corresponding to the arc profile is greater than 180 degrees, such that the second end 102 of the ejector pin 10 is not easily dropped out from the first recess 31 of the handle 3, which further ensures the firm and reliable rotational connection between the ejector pin 10 and the handle 3, such that the wrench is not prone to be damaged when the torque is relatively large.

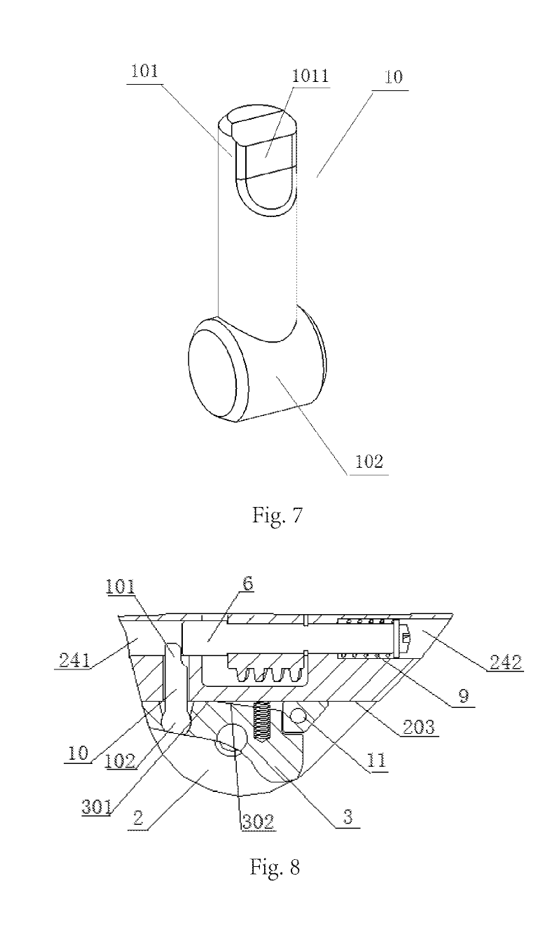

As shown in FIG. 8, a side face of the handle 3 facing a first side face 203 of the body 2 includes a first side face 301 that is parallel with the first side face 203 of the body 2, and a second side face 302 together with the first side face 203 of the body 2 forming an included angle of less than 5 degrees.

The first side face 301 of the handle 3 is parallel with the first side face 203 of the body 2, such that the handle 3 cannot rotate relative to the body 2 in a clockwise direction, which is to say that when the handle 3 is rotated in a clockwise direction, the jaw locking mechanism is not changed to the unlocked state from the locked state, but just to screw the workpiece.

The second side face 302 of the handle 3 together with the first side face 203 of the body 2 forms an included angle of less than 5 degrees, such that the handle 3 can rotate relative to the body 2 in a counter-clockwise direction, so the jaw locking mechanism is changed to the unlocked state from the locked state, and the movable jaw 5 can move in a direction away from the fixed jaw 4, thereby increasing the distance between the fixed jaw 4 and the movable jaw 5, and making the jaws to pass over the vertexes of the hexagon nut 19.

The second side face 302 of the handle 3 is provided with a blind hole 33, and a second elastic part 12 is arranged in the blind hole 33. An elastic force provided by the second elastic part 12 keeps the jaw locking mechanism 10 in the locked state, which avoids the occurrence of unreliable locking in use.

As shown in FIG. 1, the wrench provided by the present invention further includes a handle locking mechanism. If the user does not need to use the ratchet function, the handle locking mechanism can be provided at the locking position, i.e. the position close to a positioning pin 8.

The handle locking mechanism 11 is mounted to the body 2 via an elongate hole on the flange of the body 2.

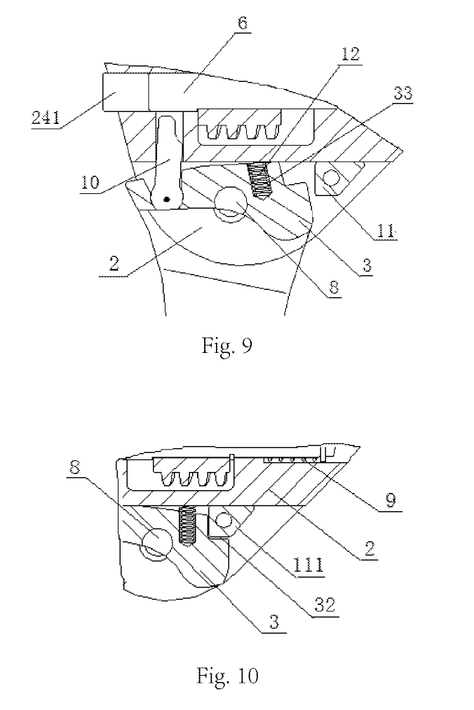

When the handle locking mechanism 11 is positioned at one end of the through-hole close to the positioning pin 8, the handle locking mechanism 11 is at the locking position. As shown in FIG. 8, the handle 3 cannot rotate relative to the body 2; the handle locking mechanism 11 is located at one end of the through-hole away from the positioning pin 8, and the handle locking mechanism 11 is at the unlocking position. As shown in FIG. 9, the handle 3 can rotate about the positioning pin 8 relative to the body 2.

The handle locking mechanism includes a button, a stop block 111 and a spring, wherein the button is used to switch the handle locking mechanism between the locking position and the unlocking position. As shown in FIG. 10, a cross-section of the stop block 111 is a right trapezoid, the profile of the cross-section of the second recess 32 of the handle 3 is rectangular, and the second recess 32 matches with a rectangular part of the right trapezoid of the stop block 111. The handle 3 is locked so that the handle 3 cannot rotate relative to the body 2.

Usually, the number of thread starts of the thread on the worm gear is one (that is, single thread), and the speed of moving the jaw is relatively slow when the worm gear is rotated, and the torque bearable by the worm gear with single thread is relatively small. With the wrench of the present embodiment, the worm gear adopts a double thread structure, which not only shortens the time required to adjust the distance between the jaws but also increases the torque bearable by the worm gear.

With regard to the wrench provided by the present invention, when the handle rotates relative to the body in a counter-clockwise direction, the jaw locking mechanism is changed to the unlocked state from the locked state, and the distance between the fixed jaw and the movable jaw is increased under the external force, thereby making the fixed jaw and the movable jaw to pass over the vertexes of the workpiece, achieving the continuous and multiple rotation of the workpiece without the need to remove the wrench from the workpiece and place it on the workpiece again, thereby improving the work efficiency of the wrench. The wrench is simple in structure, capable to bear a relatively large torque, and simplifies the fabrication process and lowers the fabrication cost. The first elastic part is provided internally, which prevents the first elastic part from contacting greasy dirt in use while making the wrench more aesthetically pleasing. The worm gear has a double thread structure, which not only shortens the time required to adjust the distance between the jaws but also increases the torque bearable by the worm gear.

The preferred specific embodiment of the invention has been described in detail above. It is to be understood that numerous modifications and variations can be made by those ordinary skilled in the art in accordance with the concepts of the present invention without any inventive effort. Therefore, the technical solutions that may be derived by those skilled in the art according to the concepts of the present invention on the basis of the prior art through logical analysis, reasoning and limited experiments should be within the scope of protection defined by the claims.

1. A wrench, comprising a body, a fixed jaw fixedly connected to the body, a movable jaw, a sliding connection component and a handle rotationally connected to the body, the movable jaw forms a sliding connection with the body via the sliding connection component, wherein the wrench further comprises a jaw locking mechanism rotationally connected to a handle, and is used to limit the movement of the sliding connection component relative to the body in a direction toward or away from the fixed jaw, the wrench further comprising a handle locking mechanism;
when the handle is rotated relative to the body in a counter-clockwise direction, the handle drives the jaw locking mechanism to change to an unlocking state from a locking state, and the movable jaw can move in a direction away from the fixed jaw under an external force.

2. The wrench according to claim 1, wherein the body is integrally formed with the fixed jaw.

3. The wrench according to claim 1, wherein the jaw locking mechanism is an ejector pin.

4. The wrench according to claim 3, wherein the sliding connection component comprises an axis pin and a worm gear provided around the axis pin, wherein the axis pin is provided in a through-hole of the body, wherein a first end of the ejector pin extends into the through-hole to prevent the axis pin from sliding, the jaw locking mechanism is in a locked state, the first end of the ejector pin retreats from the through-hole, the axis pin is slidable and the jaw locking mechanism is in an unlocked state.

5. The wrench according to claim 4, wherein the first end of the ejector pin is a column body which is partly cut out by a plane, the plane does not pass through an axis of the ejector pin and is parallel with the axis of the ejector pin, such that a contact surface between the ejector pin and the axis pin is a flat plane.

6. The wrench according to claim 4, wherein the worm gear is provided in a hollow cavity of the body, and a length of the worm gear in an axial direction of the axis pin is less than that of the hollow cavity.

7. The wrench according to claim 6, wherein a first end of the axis pin is provided with a first elastic part therearound.

8. The wrench according to claim 7, wherein the first elastic part is provided inside a hole of the body.

9. The wrench according to claim 4, wherein a second end of the ejector pin forms a rotational connection with a first recess of the handle.

10. The wrench according to claim 9, wherein the second end of the ejector pin is a cylindrical structure, and an axis of the cylinder is perpendicular to that of the ejector pin and is parallel with the contact surface between the ejector pin and the axis pin.

11. The wrench according to claim 9, wherein the first recess of the handle has an arc profile.

12. The wrench according to claim 11, wherein a central angle corresponding to the arc profile is greater than 180 degrees.

13. The wrench according to claim 4, wherein a side face of the handle relative to a first side face of the body comprises a first side face that is parallel with the first side face of the body, and a second side face together with the first side face of the body forming an included angle of less than 5 degrees.

14. The wrench according to claim 13, wherein the second side face of the handle is provided with a blind hole, and a second elastic part is arranged in the blind hole.

15. The wrench according to claim 4, wherein the worm gear has a double thread structure.

16. The wrench according to claim 1, wherein the handle locking mechanism is at the locking position, and the handle cannot rotate relative to the body; the handle locking mechanism is at the unlocking position, and the handle can rotate relative to the body.

17. The wrench according to claim 16, wherein the handle locking mechanism comprises a button and a stop block, wherein the button is used to switch the handle locking mechanism between the locking position and the unlocking position, and the stop block is used to limit the rotation of the handle relative to the body.

18. The wrench according to claim 17, wherein the stop block matches with the second recess of the handle to limit the rotation of the handle relative to the body.

19. The wrench according to claim 18, wherein a cross-section of the stop block is a right trapezoid.

20. The wrench according to claim 19, wherein the profile of the cross-section of the second recess is rectangular, and matches with a rectangular part of the right trapezoid of the stop block.
